(19) United States
(12) Patent Application Publication
(10) Pub. No.: US 2012/0093024 A1
(43) Pub. Date: Apr. 19, 2012

(54) Method for ascertaining a transmissible telegram data length

(75) Inventors: Markus Kilian, Merzhausen (DE); Andreas Seger, Zell (DE); Bert Von Stein, Zell (DE); Christian Wandrei, Weil am Rhein (DE)

(73) Assignee: Endress + Bauser GmbH + Co. KG, Maulburg (DE)

(21) Appl. No.: 13/380,114

(22) PCT Filed: May 21, 2010
(86) PCT No.: PCT/EP2010/057053

§ 371 Date: Dec. 22, 2011

(30) Foreign Application Priority Data
Jun. 24, 2009 (DE) 10 2009 027 168.6

(51) Int. Cl. H04L 12/26

(52) U.S. Cl. 370/252

(57) ABSTRACT

A method for ascertaining a transmissible telegram data length in a HART® fieldbus system. The method comprises the following steps: transmitting a test telegram between a master and a slave via the HART® fieldbus system, wherein the test telegram has a predetermined test data length; checking by the receiver of the test telegram whether the latter was received in its entirety; and determining whether this test data length is transmissible based on the result of the check.

The present invention relates to a method for ascertaining a transmissible telegram data length in a HART® fieldbus system.

In process automation technology, field devices, which serve for registering and/or influencing process variables, are often applied. Sensors, such as, for example, fill level measuring devices, flow measuring devices, pressure and temperature measuring devices, pH redox potential measuring devices, conductivity measuring devices, etc., register the corresponding process variables fill level, flow, pressure, temperature, pH value, or conductivity. Actuators, such as, for example, valves or pumps, via which the flow of a liquid in a pipeline section or the fill level in a container can be changed, serve to influence process variables. In principle, all devices, which are applied near to the process and deliver, or process, process relevant information, are referred to as field devices. A large number of such field devices are produced and sold by the firm Endress+Hauser.

In modern industrial plants, field devices are connected, as a rule, to superordinated units via bus systems (Profibus®, Foundation® Fieldbus, HART®, etc.). The superordinated units are normally control systems or control units, such as, for example, a PLC (programmable logic controller). Among other things, superordinated units serve to control, visualize, and monitor processes as well as for the start up of field devices.

In a HART® fieldbus system, a master is provided, which is, as a rule, a superordinated unit. The HART® fieldbus system is the communication connection between this master and one or more slave(s), wherein the slaves are, as a rule, field devices.

According to the HART® protocol, telegrams are embodied in such a manner that the telegrams contain control information, which forms a frame of the telegram, and user data, which forms a user data portion of the telegram. Before revision 5 of the HART® Field Communication Protocol, the data length of the user data portion of telegrams in a request telegram, which is transmitted from a master to a slave, was limited to 25 bytes and the data length of a response telegram, which is transmitted from a slave to a master, was limited to 27 bytes. Since revision 6 of the HART® Field Communication Protocol the opportunity to transfer telegrams with a data length of the user data portion of up to 255 bytes has existed. The data length of the control information, which can vary depending on application, must still be added in to ascertain the total telegram data length.

Fundamentally, the exploitation of the maximal data length of the user data portion is advantageous, since transmitting large data amounts can be performed faster and more effectively thereby. It can be a problem, however, if all components participating in the communication do not support the transmitting of telegrams with such large telegram data lengths, since error can occur in this case. Such components participating in the communication are especially each master, each slave as well as one or a number of components participating in the transmitting of telegrams, such as a multiplexer, for example, of the HART® fieldbus system. In such case, the formation of layer 2 (Data Link Layer, or security layer) of the OSI (Open System Interconnection) reference model of the respective components is especially decisive for the telegram data lengths which can be transmitted through the components concerned.

If there is no certainty whether all components participating in the communication are at least embodied according to revision 6 of the HART® Field Communication Protocol and therewith support the transmitting of telegrams with such large data lengths, especially a user data portion of up to 255 bytes, errors in the transmitting of telegrams could heretofore be prevented in that the user data portion for a request telegram was limited to 25 bytes and limited to 27 bytes for a response telegram. In this way, especially in the transmitting of large data amounts, the communication via the HART® fieldbus system is slowed significantly.

On the basis of these considerations, an object of the present invention is to provide a method, which enables an effective data transmission via a HART® fieldbus system without the occurrence of errors in the transmitting telegrams.

The object is achieved by a method for ascertaining a transmissible telegram data length in a HART® fieldbus system according to claim 1. Further developments of the invention are set forth in the dependent claims.

In the present invention, a method is provided, through which a transmissible telegram data length in a HART® fieldbus system can be ascertained. The method of the invention comprises steps as follows:

A) transmitting a test telegram between a master and a slave via the HART® fieldbus system, wherein the test telegram has a predetermined test data length;

B) checking by the receiver of the test telegram whether the test telegram was received in its entirety; and

C) determining whether this test data length is transmissible based on the result of the checking.

Accordingly, through the method of the invention, it can be determined in a simple manner whether a telegram with a certain data length can be transmitted between a master and a slave via the HART® fieldbus system. It can especially be determined through the method of the invention whether the components participating in the transmitting the test telegram support the transmitting of telegrams with a telegram data length, which corresponds to the test data length. Based on this result, data transmission (with a correspondingly adjusted telegram data length) can be performed via the HART® fieldbus system quite effectively.

No “real” data, which are relevant to process control in a plant using process automation technology, for example, are transmitted in the test telegram, but, instead, only test data. No disadvantageous effects, such as, for example, the occurrence of errors in process control, thus arise in the case a defective transmission.

If the transmitter of the test telegram does not support transmitting telegrams with such large telegram data lengths, transmitting only a part of the test telegram, for example, can occur, especially in the transmission step (step A). Additionally, it can happen in the transmission step (step A) that one or a number of components of the HART® fieldbus system, such as a multiplexer, for example, which participate in transmitting the test telegram, does not support transmitting telegrams with such large telegram data lengths.

In this case, it can especially occur that only a part of the test telegram is transmitted through the concerned component and/or the test telegram is deficiently transmitted. Furthermore, if the receiver of the test telegram does not support the reception of telegrams with such telegram data lengths, the receipt of only a part of the test telegram, for example, can occur in the transmission step (step A). All these examples of configurations lead to the result in the checking step (step B) that the test telegram was not received in its entirety.

If the checking step (step B) leads to the result that the test telegram was not received by the receiver in its entirety, then the step of determining (step C) detects that this test data length is not transmissible. As a result, telegrams with a shorter telegram data length must be applied for transmitting “actual” or “real” data via the relevant fieldbus path (between the master and the slave). In contrast, if the checking step (step B) leads to the result that the test telegram was received in its entirety, then the step of determining (step C) detects that this test data length is transmissible. As a result, telegrams with a telegram data length, which at least corresponds to the test data length, can be applied for the transmitting “actual” or “real” data via the relevant fieldbus path (between the master and the slave).

The method of the invention is especially suited to serve for “block data transfer”. This service, which is standardized in HART®, enables transmitting large data amounts between a master and a slave, wherein the data to be transferred are, as a rule, divided into a number of telegrams. Thus, through the method of the invention, a transmissible telegram data length, especially a maximum transmissible telegram data length, can be ascertained and this telegram data length can then be applied for transmitting “actual” or “real” data on the relevant fieldbus path.

As subsequently explained in reference to further developments, the test telegram having the test data length can be transmitted from a master to a slave and/or from a slave to a master. The checking step (step B), as a result thereof, is performed by the slave in the former case and by the master in the latter case. The step of determining is especially performed by the master, wherein in the former case the slave must transmit the result of the check to the master. Especially, the master is a superordinated unit (sometimes also referred to as a host) and the slave is a field device (sensor and/or actuator). As explained in the introduction, the master can especially execute process control functions in reference to the slave (field device) as well as other or alternative functions in given cases.

Additionally, the test telegram especially comprises a manufacturer specific command. In HART®, commands are applied to provide each command to be performed. These form a part of the frame (i.e. the control character) of a telegram. In addition to the standardized commands, manufacturer specific commands can also be applied in HART®; the manufacturer specific command must be known to both the transmitter as well as the receiver of the relevant telegram.

In a further development, the method of the invention is embodied in such a manner that a maximum transmissible telegram data length or a telegram data length, which is still transmissible and is as close as possible to the maximum transmissible telegram data length, can be ascertained in a HART® fieldbus system. This can, for example, be realized if the transmitted test telegram, in accordance with the method of the invention, has a test data length, which is selected to be as high as possible with, however, the expectation that transmitting such a data length is supported by at least one of the components participating in the transmission. In a further development, the test telegram has a maximum telegram data length permitted in the current version of the HART® Field Communication Protocol. Currently, this corresponds to a data length of the user data portion of the telegram of 255 bytes. The data length of the control character of the telegram is still added to this.

Sometimes the case can occur that data, which are contained in the telegram, are incorrectly transmitted by components participating in the communication. In a further development, the correct transmission can be tested and, in given cases, the correctly transmitted part can be determined when the test telegram has a random data sequence known to the master and the slave in its user data portion. Then, in the checking step (step B), the receiver of the test telegram can check whether all data of the user data portion (and the control information, in given cases) of the test telegram were correctly transmitted. Such a data sequence for the user data portion can be generated, for example, so that identical data are provided in a ring memory (also referred to as a ring buffer) in the master and slave and the starting point of the data sequence in the user data portion of the test telegram to be transmitted is, in each case, selected freely (or randomly). The starting point within the ring memory can be communicated in a separate telegram or even in the test telegram, for example.

In the simplest case, the mere receipt of the test telegram can be checked by the receiver in the checking step (step B).

However, there is also the opportunity that the test telegram, if it was received in its entirety, is checked by the receiver in the checking step (step B) in reference to other criteria and the result of the check has a number of particularized results. According to a further development, it is especially provided that the result of the check has at least one of the following particularized results:
the test telegram was received by the receiver;
the test telegram, especially the entire user data, was received by the receiver in its entirety;
the checksum of the test telegram was received by the receiver;
the checksum of the test telegram has a correct value; and/or
the user data contained in the user data portion of the test telegram were correctly received.

Additionally, the result of the check can also have still other or alternative particularized results. In such case, it is provided in a further development that the step of determining (step C) only determines that the concerned test data length can be transmitted, if all particularized results are positive (i.e. a correct transmission has taken place in reference to all criteria checked).

The receipt of the test telegram having all the user data by the receiver can be verified, for example, by checking if the value of the byte count and the data length of the user data actually received agree. The byte count forms, in such case, a part of the (standardized) control information of HART® telegrams and specifies the number of bytes between the byte count and the checksum, which is located at the end of the telegram. As a rule, the checksum (or the check byte) forms the last byte of a HART® telegram and serves for error detection. As more exactly defined in HART®, the value of the checksum is formed through an exclusive OR (XOR) of all bytes of a telegram from its start byte through to the last byte of the user data portion. The particularized result that the checksum of the test telegram was received by the receiver thus verifies that the total length of the test telegram was received and that no gap timeout occurred in the receiver. The particularized result that the checksum of the test telegram has a correct value verifies that it is highly probable that the data contained in the test telegram were transmitted correctly. Additionally, as was explained above in reference to a further development, the correctness of the data of the user data portion of the test telegram received can also still be checked (by comparison). In the latter case it can especially be checked which part of the user data portion, i.e. which user data length of the test telegram, was (correctly) received by the receiver.

In a further development it is provided that the transmissible telegram data length in the HART® fieldbus system is determined based on the result of the check, especially based on the particularized result, of which user data length of the test telegram was received by the receiver. This determination step is especially performed by the master. If this determination step is performed based on the particularized result of which user data length of the test telegram was (correctly) received by the receiver, then, for example, in cases, in which the test telegram was not transmitted in its entirety, the part of the test telegram that was correctly transmitted can be determined based on the (correctly) transmitted user data length. Based on this (correctly) transmitted user data length, then a maximum transmissible telegram data length can be determined (taking into consideration the data length of the control information). The telegrams specified for transmitting “actual” or “real” data can then have a telegram data length, which is this maximum transmissible telegram data length or is somewhat smaller than this.

In a further development, when the step of determining has the result that a test data length of a previously sent test telegram is not transmissible, then a further test telegram with a reduced test data length, in comparison to the test telegram previously sent, is transmitted between the master and the slave via the HART® fieldbus system. This further development enables an “approach” to a maximum transmissible telegram data length.

In a further development, when the step of determining has the result that a test data length of a previously sent test telegram is transmissible, then a further test telegram with an increased test data length, in comparison to the test telegram previously sent, is transmitted between the master and the slave via the HART® fieldbus system. This further development enables an “approach” to a maximum transmissible telegram data length.

In a further development, an increase or reduction of the test data length of an additional test telegram to be transmitted between the master and the slave via the HART® fieldbus system, in comparison with a previously transmitted test telegram, is determined according to a predetermined algorithm and is based on the result of the step of determining (of a previously transmitted test telegram). In such case, especially an algorithm, which enables an approach to a maximum transmissible telegram data length as rapidly as possible, can be selected. In such case, it is not absolutely necessary that the maximum transmissible telegram data length is exactly ascertained. Instead, the algorithm can be broken off as soon as a transmissible telegram data length, which lies close enough to the maximum transmissible telegram data length, is ascertained.

For example, such an algorithm can be formed by starting with a high test data length (e.g. a data length of the user data portion of 255 bytes) and the test data length (or, in given cases, only the data length of the user data portion) and halving the length until the step of determining (step C) gives a result that the test data length (of the last transmitted test telegram) is transmissible. Then, based on this last transmitted test data length, a successive increase in the test data length (or, in given cases, only the data length of the user data portion) can be performed until the step of determining (step C), in turn, gives the result that the test data length (of the last transmitted test telegram) is no longer transmissible.

In an advantageous further development, at least one multiplexer, via which the respective telegrams are transmitted, is provided in the HART® fieldbus system between the master and the slave. Such multiplexers are often applied in HART® fieldbus systems between a master and one or, as a rule, more slave(s). The received telegrams are at least partially interpreted in regard to their control information and correspondingly further transmitted by a multiplexer. Previously, the problem, especially with multiplexers, has been that these are not designed in part for transmitting telegram data lengths with a user data portion of up to 255 bytes (and additional control information). Nevertheless these are often designed to transmit telegram data lengths with a user data portion longer than 27 bytes (and additional control information). Accordingly, it can be ascertained in a simple manner through the method of the invention which telegram data length, especially which maximum telegram data length, is still transmissible through the multiplexer.

In a further development, the method is performed between the master and a number of slaves connected to the HART® fieldbus system. In this way, the transmissible telegram data length for each different path of the HART® fieldbus system and also for each different slave can be ascertained. As a rule, the transmitting test telegrams between the master and each slave occurs one after the other.

In a further development, information concerning the respective method steps is contained in information for the device integration of the slave, especially in a device description and/or in a device driver of the slave, and the master has a corresponding frame application, especially an interpreter to interpret a device description and/or an FDT frame application for a device driver, in the form of a Device Type Manager (DTM). In this way, each (as a rule, manufacturer specific) command to be installed for the steps required by method of the invention, etc. can be made known to the master in order to enable communication with the relevant slave. If a random data sequence known to the master and the slave is transmitted in the user data portion of the test telegram, then this data sequence (or the data stored in a ring memory) can also be contained in the information for the device integration of the slave.

“Information for device integration” is generally applied in order to make known to a superordinated unit or a master the functions and data provided in a slave (as a rule, a field device). Such information for device integration can comprise, for example, a device description (DD) of the slave (as a rule, a field device). The device description is normally in text form (e.g. in the ASCII text format). Depending on the fieldbus system applied, different device description languages are used, such as, for example, the HART® Device Description Language in the case of HART®. The information provided in the device description is, as a rule, interpreted or translated by an interpreter and provided to an operating program (e.g. “Application Designer” of Endress Hauser) of the master (as a rule, a superordinated unit). A device driver, especially a DTM, is device specific software, which encapsulates data and functions of the relevant slave (as a rule, a field device) and simultaneously provides graphical servicing elements. A DTM especially provides functions for the access of variables of the field device, for parametering and operation of the field device and diagnostic functions. A DTM cannot be run alone. A corresponding frame application, which is implemented in the master, serves as a runtime environment for the FDT standard.

In a further development, the test telegram is embodied as a test response telegram, which is transmitted from the slave to the master after a corresponding query telegram is transmitted from the master via the HART® fieldbus system, wherein the corresponding query telegram of the master is embodied in such a manner that the slave is requested to transmit the test response telegram by the query telegram. This further development has the advantage that both the checking step (step B) as well as the step of determining (step C) can be performed in the master. In this way, the number of telegrams transmitted can be kept low. It is especially provided that the corresponding query telegram as well as the test response telegram comprises a manufacturer specific command. Additionally, it is especially provided that the query telegram is embodied with a short data length (for example, a maximum of 25 bytes in its user data portion) in such a manner that it is transmissible from the master to the slave in any case.

In a further development, the corresponding query telegram of the master comprises other information relative to the test response telegram to be transmitted by the slave, especially information relative to the data to be transmitted in the user data portion of the test response telegram. As explained above, for example, if a ring memory is applied, the starting point of the ring memory can also be transmitted in the corresponding query telegram.

In a further development, the test telegram is embodied as a test query telegram, which is transmitted from the master to the slave via the HART® fieldbus system and which is embodied in such a manner that, through this, the slave is requested to transmit to the master in a response telegram to the test query telegram the result of the check whether the test query telegram was received in its entirety. In this further development, the checking step (step B) is especially performed in the slave, while the step of determining (step C) is performed in the master. It is especially provided that the test query telegram as well as the response telegram to the test query telegram comprises a manufacturer specific command. Additionally, it is especially provided that the response telegram to the test query telegram is embodied with a short data length (for example, a maximum of 27 bytes in its user data portion) in such a manner that it can be transmitted from the slave to the master in any case.

In a further development, it is provided that the master transmits an analysis query telegram to the slave via the HART® fieldbus system, if no response telegram to the test query telegram was received or if the response telegram to the test query telegram does not contain the result of the check, wherein the analysis query telegram is embodied in such a manner that it orders the slave to transmit the of result of the check; and wherein the analysis query telegram is embodied with a short data length in such a manner that it can be transmitted from the master to the slave in any case. In this way, the master can be informed about the result of the check. The criterion, that “the response telegram to the test query telegram does not contain the result of the check”, is also met, especially if the response telegram does not contain all of the particularized results required. Additionally, it is provided in a further development that the response telegram of the slave to the analysis query telegram is also embodied with a short data length in such a manner that it can be transmitted from the slave to the master in any case. Additionally, it is provided in a further development that the analysis query telegram as well as the associated response telegram comprises a manufacturer specific command.

Furthermore, it can also be provided that both a query telegram and the associated response telegram can be embodied, in each case, as a test query telegram and as a test response telegram. In this way, the two transmission directions between the relevant master and the relevant slave can be checked.

Other advantages and uses of the invention will become evident based on the following description of examples of embodiments in the appended drawing, the figures of which show as follows:

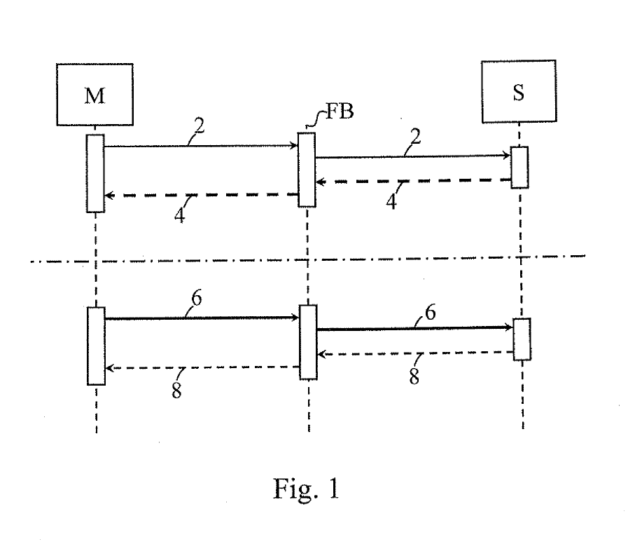

FIG. 1 a schematic representation of two communication events for the illustration of two examples of embodiments of the present invention;

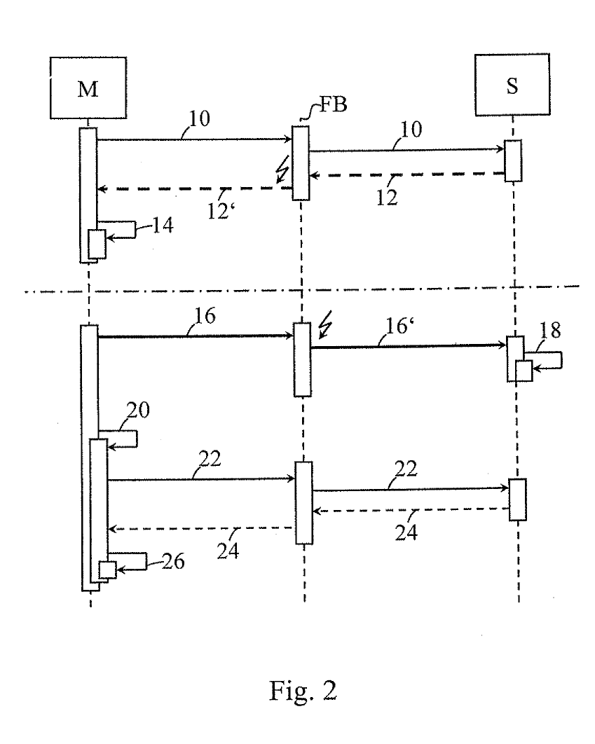

FIG. 2 a schematic representation of two communication events for the illustration of two additional examples of embodiments of the present invention;

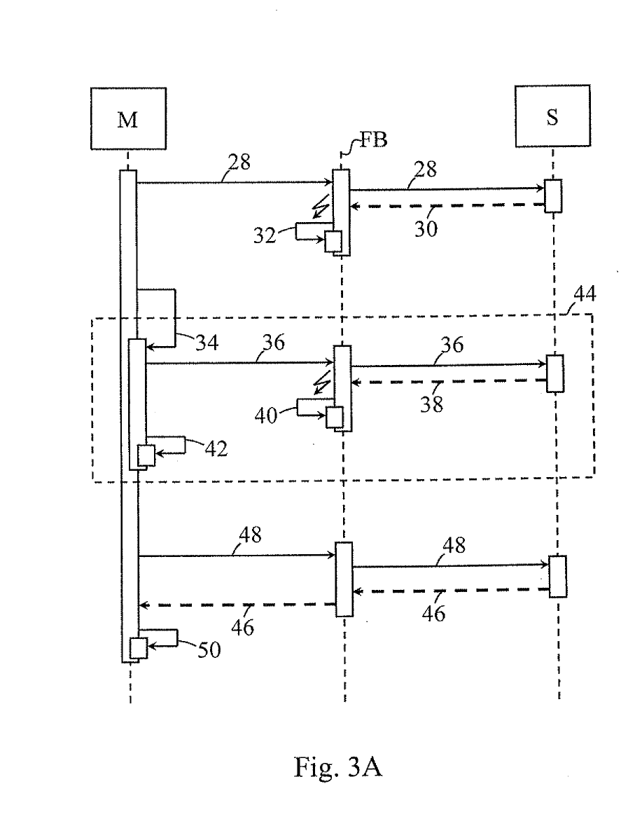

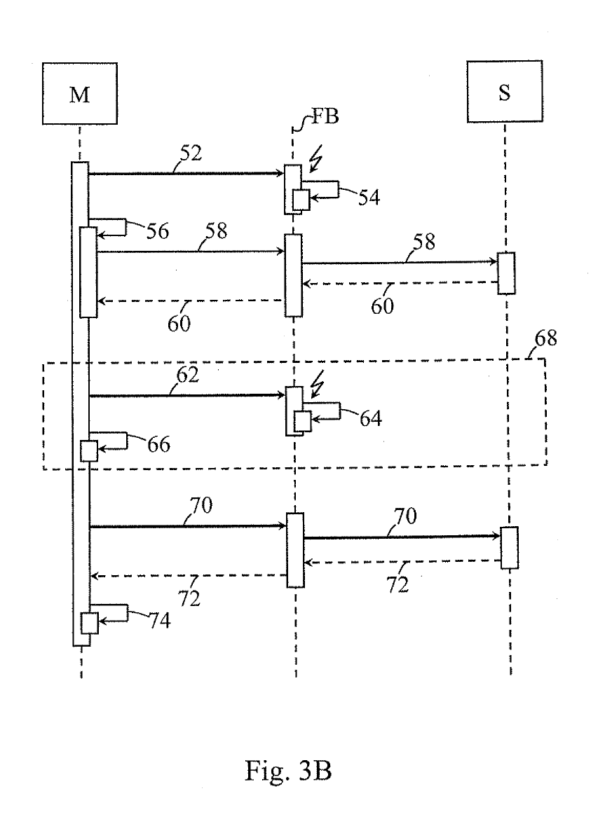

FIG. 3A a schematic representation of a communication event for the illustration of an additional example of an embodiment of the present invention;

FIG. 3B a schematic representation of a communication event for the illustration of an additional example of an embodiment of the present invention; and

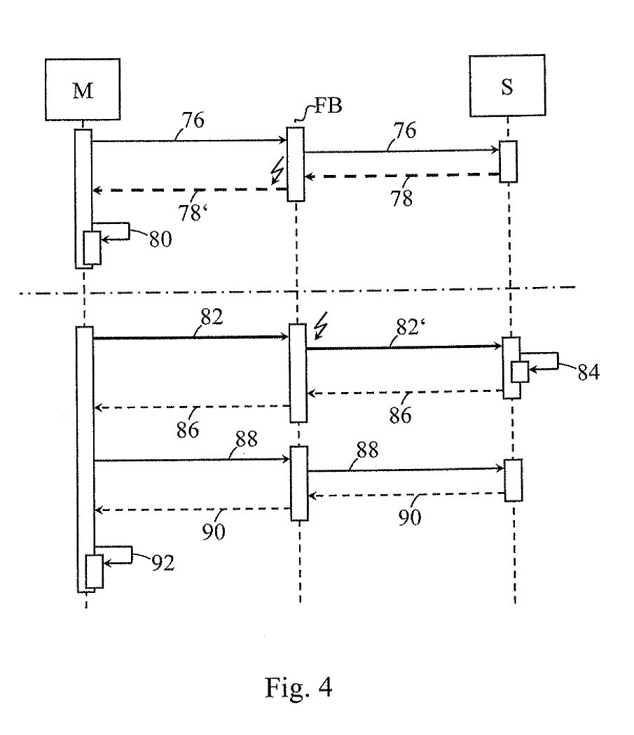

FIG. 4 a schematic representation of two communication events for the illustration of two additional examples of embodiments of the present invention.

A master M, a slave S and a HART® fieldbus topology FB are presented in each of the FIGS. 1 to 4. The communication planes of these three components M, S and FB participating in the communication are, in each case, represented as vertical, dashed lines. The master M is embodied as a superordinated unit and slave S as a field device in the examples of embodiments. Master M and slave S are connected to a hardwired HART® fieldbus system, wherein the transmitting of telegrams between master M and slave S occurs via a multiplexer (not shown). The HART® fieldbus system, together with the multiplexer, is referred to as a HART® fieldbus topology FB in the present context. Additionally, query telegrams (from master M to slave S) are represented as solid lines in any case and response telegrams (from slave S to master M) are represented as dashed lines in each case in FIGS. 1 to 4. If the relevant telegram is a test telegram according to the present invention, then this is represented as a bold line.

In FIGS. 1 to 4, the test telegram (or the first test telegram sent) comprises a user data portion with a data length of 255 bytes in each case. The data length of the control information of the test telegram is then added to these 255 bytes so that the test data length results therefrom. In this way, it can be checked whether all components (master M, slave S, fieldbus topology FB) participating in the communication support transmitting telegrams with such a large test data length. This is, for example, the case when all components participating in the communication are embodied at least according to revision 6 of the HART® Field Communication Protocol.

FIG. 1 shows the case where all components (master M, slave S, fieldbus topology FB) participating in the communication support the transmitting of such a test data length.

A first example of an embodiment of the invention is presented in the upper half of FIG. 1. Master M first transmits a corresponding query telegram 2 to slave S via fieldbus topology FB. Query telegram 2 contains a manufacturer specific command, by which slave S is requested to transmit a test response telegram to master M. Additionally, in the present example of an embodiment, query telegram 2 comprises still other information relative to the test response telegram to be transmitted by slave S. It is therein especially given what data length the user data portion of the test response telegram should have (255 bytes here). Additionally, both master M and slave S contain a ring memory, in each of which identical test data are stored. In query telegram 2, a starting point within the ring memory is also transmitted for test data to be transmitted in the user data portion of the test response telegram. Depending on the embodiment of the method of the invention, query telegram 2 can also have no or alternative information relative to the test response telegram to be transmitted by slave S.

Query telegram 2 is embodied, in such case, with a short data length in such a manner that it can be transmitted from master M to slave S in any case. In the present case, the user data portion of query telegram 2 has a maximal data length of 25 bytes. In this way, it is assured that query telegram 2 can then be transmitted from master M to slave S in its entirety if one or more of the component(s) participating in the communication is/are not embodied at least according to revision 6 of the HART® Field Communication Protocol.

After the receipt of query telegram 2, slave S transmits a test response telegram 4 to master M; test response telegram 4 contains the test data specified above in its user data portion. Test response telegram 4 is faultlessly transmitted by all components participating in the communication (master M, slave S, fieldbus topology FB). It is then checked in master M whether test response telegram 4 was received in its entirety. Especially in such case, the following criteria are checked by master M:
whether the test response telegram was received;
whether the test response telegram was received with all the user data;
whether the checksum of the test response telegram was received;
whether the checksum of the test response telegram has a correct value; as well as
whether the user data (test data) contained in the user data portion of the test response telegram were correctly received.

In the present example of an embodiment, all criteria are fulfilled; therefore all particularized results of the check are positive. Then, it is determined in master M that the concerned test data length can be transmitted.

Referencing FIG. 1 in the following, a second example of an embodiment of the present invention is explained, whose communication event in FIG. 1 is represented below the dot dashed line. In such case, the differences from the first example of an embodiment are first explored.

Master M first transmits a test query telegram 6 to slave S via fieldbus topology FB. The test query telegram 6 contains a manufacturer specific command, by which slave S is requested to transmit the result of the check whether the test query telegram 6 was received in its entirety by slave S in a response telegram. Again, test data are transmitted in the user data portion of test query telegram 6; the test data are stored in an associated ring memory in both master M and slave S. In such case, the starting point within the ring memory for the transmitted test data is also transmitted in test query telegram 6 in the present example of an embodiment. Alternatively, this starting point can also be transmitted in a separate telegram.

Test query telegram 6 is faultlessly transmitted by all components participating in the communication (master M, slave S, fieldbus topology FB). It is then checked in slave S whether the test query telegram 6 was received in its entirety. In such case, the received test query telegram 6 is checked in slave S in a corresponding manner in reference to the criteria in the first example of an embodiment explained above.

All criteria are fulfilled in the present example of an embodiment so that all particularized results of the check are positive. These particularized results of the check are then transmitted from slave S to master M in a response telegram 8.

In turn, response telegram 8 is embodied with a short data length (maximal data length of the user data portion is 27 bytes) in such a manner that it can be transmitted from slave S to master M in any case. Then, it is determined in master M whether the concerned test data length can be transmitted.

Telegrams with this maximal data length can be applied in both the first and second example of an embodiment for the transmitting of “real” data. In given cases, the telegram data length for transmitting “real” data can also be limited to a data length somewhat shorter than the test data length.

FIG. 2 shows the case when telegrams with the test data length (data length of the user data portion of 255 bytes) are cut off by the HART® fieldbus topology FB, especially by the multiplexer, and only the first part of the relevant telegram is transmitted.

A third example of an embodiment of the present invention is presented in the upper half of FIG. 2, in the case of which subsequently the differences from the first example of an embodiment are primarily explored. Again, master M transmits a corresponding query telegram 10 to slave S via fieldbus topology FB. Query telegram 10 is correspondingly embodied as query telegram 2 of the first example of an embodiment. After the receipt of query telegram 10, slave S transmits a test response telegram 12 to master M; test response telegram 12 contains the requested test data in its user data portion. Test response telegram 12 is cut off by the multiplexer during the transmission and only the first part 12′ of test response telegram 12 is transmitted further.

Master M continues to receive until the checksum (which is located at the end of HART® telegrams) is received or until a timeout, which is referred to as a gap timeout, occurs. Presently, first part 12′ of test response telegram 12 contains no checksum, so master M breaks off reception after the occurrence of a gap timeout. Then, the criteria, in reference to the first example of an embodiment explained above, are checked in reference to a receipt of the entirety of test response telegram 12 in master M. In the present example of an embodiment, this checking step gives the result that, among other things, the checksum and also a part of the user data portion of test response telegram 12 were not received. Additionally, master M, in the checking step, tests which user data length (or which first part of the user data) of test response telegram 12 was received correctly and determines the maximum transmissible telegram data length therefrom (taking into consideration the data length of the control information). The steps performed by master M after the receipt of test response telegram 12 are represented in FIG. 2 by the returning arrow 14.

In reference to FIG. 2, a fourth example of an embodiment of the present invention is explained in the following; the communication event of this fourth example is presented below the dot dashed line in FIG. 2. In such case, the differences from the second example of an embodiment are primarily explored.

Master M first transmits a test query telegram 16 to slave S via fieldbus topology FB. Test query telegram 16 is correspondingly embodied as test query telegram 6, as it was explained in reference to the second example of an embodiment. Test query telegram 16 is cut off by the multiplexer during the transmission and only the first part 16′ of test query telegram 16 is transmitted further.

As was explained in the third example of an embodiment in reference to the receipt procedure of master M, slave S stops receiving after the occurrence of a gap timeout since the checksum is not contained in the transmitted first part 16′ of the test query telegram 16. This is presented schematically by the returning arrow 18 in FIG. 2. Then, the criteria, in reference to the first example of an embodiment explained above, are checked in slave S in reference to a receipt of test query telegram 16 in its entirety. In the present example of an embodiment, this checking step gives the result that, among other things, the checksum and also a part of the user data portion of test query telegram 16 were not received. Additionally, in the checking step, slave S tests which user data length (or which first part of the user data) of test query telegram 16 was correctly received. Since no response telegram to test query telegram 16 is received by master M, a response timeout occurs in master M; this is presented schematically by the returning arrow 20 in FIG. 2.

In the next step, master M transmits an analysis query telegram 22 to slave S. The analysis query telegram 22 contains a manufacturer specific command, by which slave S is requested to transmit the result of the check, especially the particularized results mentioned above, in a response telegram. Then, slave S transmits the particularized results, which were obtained in the checking step, in a response telegram 24. Both analysis query telegram 22 and associated response telegram 24 are embodied with a short data length (e.g. maximal data length of the user data portion of the analysis query telegram is 25 bytes; maximal data length of the user data portion of the associated response telegram is 27 bytes) in such a manner that they can be transmitted between slave S and master M in any case.

Master M determines that the test data length cannot be transmitted based on the received particularized results. Additionally, it determines from the particularized results, especially from the particularized result, which user data length (or which first part of the user data) of test query telegram 16 was correctly received, the maximum transmissible telegram data length (taking into consideration the data length of the control information). These steps of master M are represented by the returning arrow 26 in FIG. 2

Telegrams having the determined, maximal data length can be applied for the transmitting “real” data in both the third and fourth examples of an embodiment. In given cases, the telegram data length for transmitting “real” data can also be limited to a data length somewhat shorter than the fixed, maximum data length. Additionally, an additional test telegram, which determines whether the fixed, maximum telegram data length can actually be transmitted faultlessly and in its entirety, can be supplementally provided before the transmitting of “real” data is tested.

FIGS. 3A and 3B present the case when telegrams with the test data length (data length of the user data portion of 255 bytes) are completely dropped by the HART® fieldbus topology FB, especially the multiplexer, and therewith are not transmitted further.

In the following, a fifth example of an embodiment is explained in reference to FIG. 3A, wherein the differences from the third example of an embodiment are primarily explored. Again, master M transmits a corresponding query telegram 28 to slave S via fieldbus topology FB. Query telegram 28 is correspondingly embodied as query telegram 2 from the first example of an embodiment. After the reception of query telegram 28, slave S transmits a test response telegram 30 to master M; test response telegram 30 contains the requested test data in its user data portion. The test response telegram 30 is dropped by the multiplexer during the transmission; this is represented by the returning arrow 32 in FIG. 3A. Since no test response telegram is received by master M, a response timeout occurs in master M. The master M accordingly determines that the test data length cannot be transmitted. These steps of master M are represented by the returning arrow 34 in FIG. 3A.

In the next step master M transmits an additional query telegram 36 to slave S via fieldbus topology FB, wherein the additional query telegram 36 requests that slave S transmit a test response telegram with a test data length, which is reduced compared to test response telegram 30 previously sent. Thereupon slave S transmits the additional test response telegram 38, which has a correspondingly reduced test data length, to master M. Again, the additional test response telegram 38 is dropped by the multiplexer during the transmission, which is represented by the returning arrow 40 in FIG. 3A. Since no test response telegram is received by master M, a response timeout occurs in master M; the response timeout is represented by the returning arrow 42 in FIG. 3A. This loop described in this paragraph, which is represented by a dashed box 44 in FIG. 3A, is repeated, until, as subsequently explained, a successful transmitting of a test response telegram takes place.

Such a successful transmitting of a test response telegram 46 having a correspondingly reduced test data length, which is transmitted in answer to a corresponding query telegram 48, is presented below dashed box 44 in FIG. 3A. It is then checked in master M whether the test response telegram 46 was received in its entirety, wherein especially the criteria explained in reference to the first example of an embodiment are checked. In the present example of an embodiment, all criteria are fulfilled. Then, it is determined in master M that the concerned (reduced) test data length can be transmitted. As a result “real” data telegrams with this data length or a slightly reduced data length can be applied for the transmission. The steps performed by master M are represented by the returning arrow 50 in FIG. 3A.

A sixth example of an embodiment is explained in the following in reference to FIG. 3B, wherein the differences from the fourth example of an embodiment are primarily explored.

Master M first transmits a test query telegram 52 to slave S via fieldbus topology FB. Test query telegram 52 is correspondingly embodied as test query telegram 6, as it was explained in reference to the second example of an embodiment. Test query telegram 52 is dropped by the multiplexer during the transmission, which is represented by the returning arrow 54 in FIG. 3B. Since no response telegram to test query telegram 52 is received by master M, a response timeout occurs in master M, which is represented by the returning arrow 56 in FIG. 3B.

In the next step, master M transmits an analysis query telegram 58, which is correspondingly embodied as analysis query telegram 22 from the fourth form of embodiment, to slave S. Then, slave S transmits only the particularized result that no test query telegram was received by slave S in a response telegram 60, which is correspondingly embodied as response telegram 24 from the fourth form of embodiment, to the analysis query telegram 58. A further check of the different criteria by slave S is unnecessary in the present configuration. Then, master M determines that the test data length cannot be transmitted based on the particularized result received.

In the next step, master M transmits an additional test query telegram 62 to slave S via fieldbus topology FB. Additional test query telegram 62 has a reduced test data length in comparison to the test query telegram 52 previously sent. Again, additional test query telegram 62 is dropped by the multiplexer during the transmission, which is represented by the returning arrow 64 in FIG. 3B. Since no response telegram to additional test query telegram 62 is received by master M, a response timeout occurs in master M. Then, master M determines that the reduced test data length cannot be transmitted. These steps of master M are represented by the returning arrow 66 in FIG. 3B. This loop described in this paragraph, which is represented by a dashed box 68 in FIG. 3B, as subsequently explained, is repeated until successful transmitting of a test query telegram takes place.

Such a successful transmitting of test response telegram 70, which has a correspondingly reduced test data length and is transmitted in answer to a corresponding query telegram 72, is presented below dashed box 68 in FIG. 3A. This communication event corresponds to the communication explained in the second example of an embodiment in reference to test query telegram 6 and response telegram 8. Then, it is determined in master M that the concerned (reduced) test data length can be transmitted. As a result “real” data telegrams with this data length or a slightly reduced data length can be applied for the transmission. The steps performed by master M are represented by the returning arrow 74 in FIG. 3B.

In such case, it is not absolutely required that the method illustrated in FIGS. 3A and 3B be broken off after the first successful transmitting of a test telegram. Rather, a maximum transmissible telegram data length can be more exactly determined through other steps, especially through subsequent increases of the test data length of an additional test telegram to be transmitted. An algorithm can especially be applied for this, as was explained in the introductory part of the description.

FIG. 4 shows the case when telegrams with the test data length (data length of the user data portion of 255 bytes) are not shortened by HART® fieldbus topology FB, especially by the multiplexer; however, the bytes to be transferred are transmitted incorrectly. This case can occur, for example, when data of a telegram are temporarily stored in a buffer memory, in a buffer memory of a multiplexer for example, during the transmission; the buffer memory is not designed to store such large data amounts and therewith data are partially overwritten. Such a defective transmission can especially be detected and more exactly analyzed when a random data sequence known to master M and slave S is transmitted in the user data portion in the respective test telegram. Such test data are stored in a ring memory of master M and of slave S in the two examples of embodiments subsequently explained. In reference to these test data, reference is made to the explanation of the first example of an embodiment.

In the following, a seventh example of an embodiment is explained in reference to the upper half of FIG. 4; wherein the differences from the first example of an embodiment are primarily explored. Master M transmits a corresponding query telegram 76 to slave S via fieldbus topology FB. The query telegram 76 is embodied corresponding to query telegram 2 of the first example of an embodiment. After the reception of query telegram 76, slave S transmits a test response telegram 78, which contains the test data requested in its user data portion, to master M. The bytes of test response telegram 78 to be transferred are incorrectly transmitted by the multiplexer, so that a changed test response telegram 78′ arrives at master M.

Then, the criteria, in reference to the first example of an embodiment explained above, are checked in master M in reference to a receipt of test response telegram 78 in its entirety. In the present example of an embodiment, this checking step has the result that, among other things, the checksum of the test response telegram 78′ received does not have a correct value and that the user data, contained in the user data portion of test response telegram 78′ received, were not correctly received. Additionally, master M tests which user data length (or which first part of the user data) of test response telegram 78 was correctly received in the checking step and determines the maximum transmissible telegram data length therefrom (taking into consideration the data length of the control information). The steps performed by master M after the receipt of response telegram 78′ are represented by the returning arrow 80 in FIG. 4.

In the following, an eighth example of an embodiment of the present invention is explained in reference to FIG. 4, the communication event of this eighth example of an embodiment is presented below the dot dashed line in FIG. 4. In such case, the differences from the second example of an embodiment are primarily explored.

Master M first transmits a test query telegram 82 to slave S via fieldbus topology FB. The query telegram 82 is embodied corresponding to query telegram 6, as it was explained in the second example of an embodiment. The bytes of test query telegram 82 to be transferred are incorrectly transmitted by the multiplexer so that a changed test query telegram 82′ arrives at slave S.

Then, the criteria, in reference to the first example of an embodiment explained above, are checked by slave S in reference to receipt of test query telegram 82 in its entirety. In the present example of an embodiment, this checking step has the result that, among other things, the checksum of the test query telegram 82′ received does not have a correct value and that the user data, contained in the user data portion of test query telegram 82′ received, were not correctly received. In the checking step, slave S additionally tests which user data length (or which first part of the user data) of test query telegram 82 was correctly received. These steps of slave S are represented by the returning arrow 84 in FIG. 4.

Since, in the present case, the checksum does not have a correct value, a check sum defective telegram, as provided according to the HART® standard, is sent as a response telegram 86 to test query telegram 82; the check sum defective telegram only communicates that test query telegram 82 contains a defective checksum.

Since response telegram 86 to test query telegram 82 does not contain the result of the check in its entirety, master M transmits an analysis query telegram 88 to slave S. Then, slave S transmits the particularized results, which were obtained in the checking step, in a response telegram 90 to analysis query telegram 88. Analysis query telegram 88 and associated response telegram 90 are embodied corresponding to analysis query telegram 22 and response telegram 24, which were explained in the fourth example of an embodiment.

Master M then determines that the test data length cannot be transmitted based on the particularized results received. Additionally, it determines the maximum transmissible telegram data length from the particularized results, especially from the individual result, of which user data length (or which first part the user data) of test query telegram 82 was correctly received (taking into consideration the data length of the control information). These steps of master M are represented by the returning arrow 92 in FIG. 4.

In the seventh and eighth examples of an embodiment, “real” data telegrams with this maximal data length or also a somewhat shorter data length can also be applied, as was correspondingly explained in the third form of embodiment, for the transmission. Additionally, an additional test telegram, which has the determined, maximum transmissible telegram data length, can be transmitted in a corresponding manner in order to test its defect free transmission.

1-15. (canceled)

16. A method for ascertaining a transmissible telegram data length in a HART® fieldbus system, comprising the steps of:
transmitting a test telegram between a master and a slave via the HART® fieldbus system, wherein the test telegram has a predetermined test data length;
checking by the receiver of the test telegram whether the test telegram was received in its entirety; and
determining whether this test data length can be transmitted based on the result of the checking.

17. The method as claimed in claim 16, wherein:
the test telegram has a maximum telegram data length permitted in the current version of the HART® Field Communication Protocol.

18. The method as claimed in claim 16, wherein:
the test telegram has a random data sequence known to the master and the slave in its user data portion.

19. The method as claimed in claim 16, wherein:
the result of said checking has at least one of the following particularized results:
the test telegram was received by the receiver;
the test telegram was received by the receiver in its entirety;
the checksum of the test telegram was received by the receiver;
the checksum of the test telegram has a correct value; and/or
the user data contained in the user data portion of the test telegram were correctly received.

20. The method as claimed in claim 16, wherein:
the telegram data length that can be transmitted in the HART® fieldbus system is determined based on the result of said checking, especially based on the particularized result, which user data length of the test telegram was received by the receiver.

21. The method as claimed in claim 16, wherein:
the step of determining has the result that a test data length of a test telegram previously sent cannot be transmitted, an additional test telegram having a reduced test data length, in comparison to the previously sent test telegram, is transmitted between the master and the slave via the HART® fieldbus system.

22. The method as claimed in claim 16, wherein:
when the step of determining has the result that a test data length of a test telegram previously sent can be transmitted, an additional test telegram with an increased test data length, in comparison to the test telegram previously sent, is transmitted between the master and the slave via the HART® fieldbus system.

23. The method as claimed in claim 16, wherein:
an increase or decrease of the test data length, in comparison to a previously transmitted test telegram, of an additional test telegram to be transmitted between the master and the slave via the HART® fieldbus system is determined using a predetermined algorithm and is based on the result of the step of determining for a previously transmitted test telegram (30; 38; 52; 62).

24. The method as claimed in claim 16, wherein:
at least one multiplexer, via which the respective telegrams are transmitted between the master and the slave, is provided in the HART® fieldbus system.

25. The method as claimed in claim 16, wherein:
the method is performed between the master and a number of slaves connected to the HART® fieldbus system.

26. The method as claimed in claim 16, wherein:
information concerning the respective method steps is contained in information for the device integration of the slave, especially in a device description and/or in a device driver for the slave, and that the master has a corresponding frame application, especially an interpreter for interpreting a device description and/or a FDT frame application for a device driver in the form of a Device Type Manager.

27. The method as claimed in claim 16, wherein:
the test telegram is a test response telegram, which is transmitted from the slave to the master in response to a corresponding query telegram from the master via the HART® fieldbus system; and
the corresponding query telegram of the master is embodied in such a manner that the slave is requested to transmit the test response telegram by the query telegram.

28. The method as claimed in claim 27, wherein:
the corresponding query telegram of the master contains other information relative to the test response telegram to be transmitted to the slave, especially information relative to the data in the user data portion of the test response telegram to be transmitted.

29. The method as claimed in claim 16, wherein:
the test telegram is a test query telegram, which is transmitted from the master to the slave via the HART® fieldbus system and is embodied in such a manner that the slave is requested by the test telegram to transmit to the master the result of the check of whether the test query telegram was received in its entirety in a response telegram to the test query telegram.

30. The method as claimed in claim 29, wherein:
the master transmits an analysis query telegram to the slave via the HART® fieldbus system, if no response telegram to the test query telegram was received or if the response telegram to the test query telegram does not contain the result of the check;
the analysis query telegram is embodied in such a manner that it requests the slave to transmit the result of the check; and
wherein the analysis query telegram has such a short data length that the analysis query telegram can be transmitted from the master to the slave in any case.
